(19) United States
(12) Patent Application Publication
(10) Pub. No.: US 2008/0065632 A1
(43) Pub. Date: Mar. 13, 2008

(54) SERVER, METHOD AND SYSTEM FOR PROVIDING INFORMATION SEARCH SERVICE BY USING WEB PAGE SEGMENTED INTO SEVERAL INFORAMTION BLOCKS

(75) Inventors: Se-dong Nam, Seoul (KR); Joong-ho Shin, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: CHUTNOON INC., Seongnam-si (KR)

(21) Appl. No.: 11/849,955

(22) Filed: Sep. 4, 2007

(30) Foreign Application Priority Data
Mar. 4, 2005 (KR) 10-2005-0018310
Mar. 3, 2006 (KR) 10-2006-0020349

(51) Int. Cl. G06F 17/30

(52) U.S. Cl. 707/6; 707/E17.008

(57) ABSTRACT

Disclosed is a method, system, and server for providing an information search service using a web page divided into a plurality of information blocks. The method of providing a division search service includes: (a) analyzing collected data to divide each of the data into a plurality of information blocks; (b) creating an index of each of the information blocks; and (c) comparing the index with a keyword, creating a division search result of the keyword based on a relevance between the index and the keyword, and providing the division search result.

### TECHNICAL FIELD

The present invention relates to an information search service and, more particularly, to a method, system, and server for providing an information search service using a web page divided into a plurality of information blocks.

### BACKGROUND ART

With the development of the Internet, Internet information search techniques have been greatly improved so that an enormous amount of information can be processed and accumulated on the Internet and users can search for information quickly and accurately.

The Internet information search techniques allow users to use web browsers to easily search for various information, such as images, voice, and moving pictures, on the Internet. However, the search techniques have a disadvantage in that they do not give the users information concerning which includes information necessary to the users among web sites increasing in geometric progression. One of the most general approaches to overcome the disadvantage is using a search engine.

The search engine implies a program designed to help find information stored on a computer system such as the World Wide Web inside a corporate or proprietary network or a personal computer. It makes an index of information of web sites by a search program, such as search robot or web spider, and stores the indexed information in a database. It allows users to ask for content meeting specific criteria (typically those containing a given word or phrase) and retrieves a list of references that match those criteria.

The search engine typically searches for web pages containing a term matching a query inputted from a user. The search engine sorts search results according to accuracy or significance based on an internal criterion, and provides the search results to the user. The search engine has a significant amount of indexed web pages, and typically provides tens of thousands of to hundreds of thousands of web pages, or billions of web pages. However, only a few of the web pages include information that the user searches for.

Accordingly, the search engine introduces a ranking system in which information necessary to the user is output with high priority. The ranking system implies a logical system that analyzes information existing inside web pages and information existing outside but related to the web pages, and determines a priority order of the web pages based on an internal criterion.

The search engine considers frequency of a query, frequency of back reference, spam filtering, and the like in order to accurately define the ranking system. That is, the search engine sorts the search results according to the frequency of query, frequency of back reference, or spam filtering, thereby logically establishing the ranking system.

An information search method using the above-mentioned typical search engine takes account of the frequency of query, frequency of link, span filtering, whether or not a query is contained in individual web pages, or whether or not a link text is reflected. That is, the information search method searches for web pages containing the query in web page units, and provides the web pages to the user according to the ranking system.

Meanwhile, the web page typically consists of a Hyper Text Markup Language (HTML) tag and a text, which are written using markup language syntax. In addition, the web page includes a tag for indicating basic information, and a text. That is, the web page includes information blocks, such as title, writer, number of references, and text, which are distinguished by tags.

Information searched by a user may be contained in a specified one of the information blocks according to its type or attribute. For instance, when the user intends to search for web pages titled “A stock story” written by “Kim” web pages containing a reference word “Kim” in an information block of “writer” are more likely to be web pages containing information searched by the user than web pages containing the reference word “Kim” in an information block of “title”, “text” or “number of references”. Thus, when a query is received from the user and an information search is made accordingly, only an information block corresponding to the query may be selected and searched so as to provide the user with information close to the user's desired information. Alternatively, different weights may be put on individual information blocks to calculate an evaluation value which is used to determine a priority order, such that search results are provided according to the priority order.

However, the conventional search method simply makes a search in web page units. It does not divides information contained in a web page into information blocks to make a search based on the individual information blocks. Further, it does not put different weights on the individual information blocks to calculate an evaluation value.

Meanwhile, a web page provided by a server enables users to make a search based on individual items. However, the users can make a search only through a database managed by the server. That is, the users cannot search for web pages in information block units on the entire Internet.

### DISCLOSURE OF INVENTION

Technical Solution

The present invention provides a method, system, and server for providing an information search service, which divides a web page into a plurality of information blocks according to the attribute of information contained in the web page, indexes the information blocks, and makes a selective search in information block units, or makes a search according to a priority order determined by putting different weights on the individual information blocks and calculating an evaluation value therefrom.

Advantageous Effects

According to the present invention, it is possible for users to conveniently search for information on the Internet in information block units, and to obtain accurate search results by putting different weights on the individual information blocks to calculate an evaluation value, determining a priority order based on the evaluation value, and outputting the search results according to the priority order.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system for providing an information search service using a web page divided into a plurality of information blocks according to an embodiment of the present invention;

FIG. 2 is a block diagram of a division search server according to an embodiment of the present invention;

FIGS. 3 and 4 are views for explaining a method of determining a priority order according to an embodiment of the present invention;

FIG. 5 is a flow chart of a method of providing an information search service using a web page divided into a plurality of information blocks according to an embodiment of the present invention; and

FIG. 6 is a division search result according to an embodiment of the present invention.

### BEST MODE FOR CARRYING OUT THE INVENTION

According to an aspect of the present invention, there is provided a method of providing a division search service, including: (a) analyzing collected data to divide each of the data into a plurality of information blocks; (b) creating an index of each of the information blocks; and (c) comparing the index with a keyword, creating a division search result of the keyword based on a relevance between the index and the keyword, and providing the division search result.

According to another aspect of the present invention, there is provided a method of providing a division search service in a system including a user terminal transmitting a query and outputting a search result, a web server providing a plurality of web pages, and a division search server receiving the query from the user terminal and creating and transmitting the search result to the user terminal, the method including: (a) receiving the query and a division search request signal from the user terminal; (b) receiving a web page from the web server; (c) dividing the web page into a plurality of information blocks; (d) extracting an index corresponding to each of the information blocks from the divided web page and creating index information and URL information of a reference web page referenced by the index; and (e) searching an index that is equal or related to the query to create a division search result, and transmitting the division search result to the user terminal.

According to another aspect of the present invention, there is provided a system for providing a division search service from information in a plurality of web pages on a wireless/wireline communication network, including: a user terminal performing web surfing over the wireless/wireline communication network, transmitting a query and a search request signal, receiving and outputting a division search result to a display unit; a web server creating the information as a plurality of web pages; and a division search server dividing the web page into a plurality of information blocks, using the divided web page to search for the information, creating and transmitting the division search result to the user terminal.

According to another aspect of the present invention, there is provided a server for providing a division search service, including: a page-dividing module analyzing collected data to divide each of data into a plurality of information blocks; an index management module creating an index of each of the information blocks; and a controller comparing the index with a keyword, creating a division search result of the keyword based on a relevance between the index and the keyword, and providing the division search result.

According to another aspect of the present invention, there is provided a server for providing a division search service by receiving a query and a search request signal from a user terminal performing web surfing over a wireless/wireline communication network, searching for information on a web page provided by a web server, and tr ansmitting a search result to the user terminal, the server including: a web page collection module executing a web page collection program to receive the web pages from the web server accessing the wireless/wireline communication network and store the web pages; a URL pattern creation module analyzing the web pages to create the URL pattern; a page-dividing module using the URL pattern to extract a HTML template from the web page, and using the HTML template to divide the web page into a plurality of information blocks; an index management module extracting an index corresponding to each of the information blocks in the divided web page to create and store index information and URL information of a reference web page referenced by the index; a query management module receiving the query and the information search request signal from the user terminal, searching for an index equal or related to the query, creating and transmitting a division search result to the user terminal; and a controller controlling the web page collection module, the URL pattern creation module, the page-dividing module, the index management module, and the query management module so that the division search server can use the divided web page to make a search, and controlling so that the division search server can communicate with the user terminal and the web server over the wireless/wireline communication network.

Mode for the Invention

Exemplary embodiments in accordance with the present invention will now be described in detail with reference to the accompanying drawings.

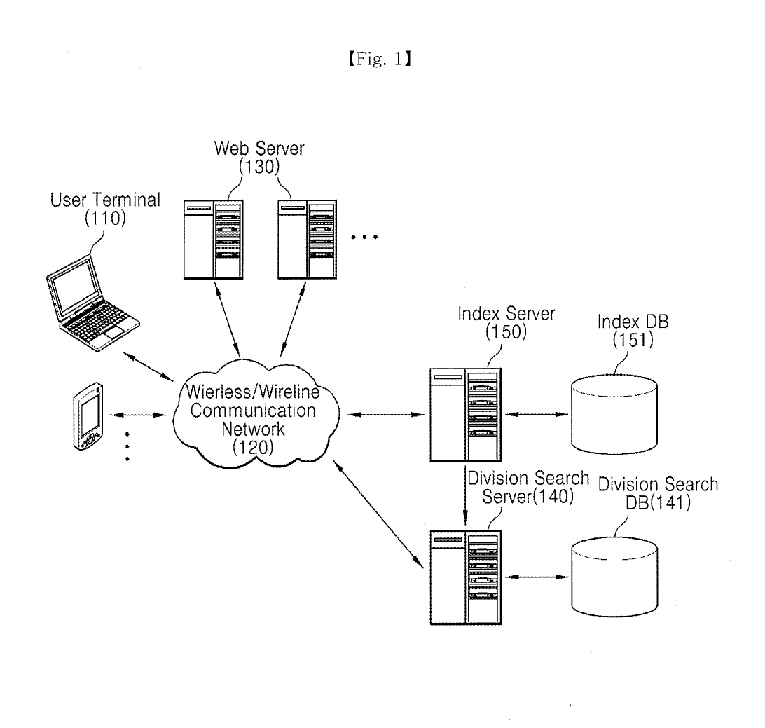

FIG. 1 is a block diagram of a system for providing an information search service using a web page divided into a plurality of information blocks according to an embodiment of the present invention.

A system for providing an information search service using a web page divided into a plurality of information blocks according to an embodiment of the present invention includes a user terminal 110, a wireless/wireline communication network 120, a web server 130, a division search server 140, a division search database (hereinafter referred to as ‘DB’) 141, an index server 150, and an index DB 151.

The user terminal 110 accesses the division search server 14 over the wireless/wireline communication network 120, transmits a query and a search request signal, receives a division search result from the division search server 140, and outputs the division search result to a display unit.

The user terminal 110 includes a wireline communication unit including an Internet modem, such as Very High Data Rate Digital Subscriber Line (VDSL) modem and cable modem, and/or a mobile communication unit including a mobile communication modem, such as Code Division Multiple Access (CDMA) 2000 modem and Wideband CDMA (W-CDMA) modem, to access the division search server 140 over the wireless/wireline communication network 120. The user terminal further includes a controller including a memory storing web browser programs for receiving a query from a user, requesting information search, and outputting search results to a display unit, and a microprocessor controlling the operation of the user terminal 110.

Examples of the user terminal 110 include a personal computer (PC), such as desktop or laptop, and a mobile communication terminal, such as Personal Digital Assistant (PDA), cellular phone, Personal Communication Service (PCS) phone, hand-held PC, Global System for Mobile (GSM) phone, W-CDMA phone, CDMA-2000 phone, and Mobile Broadband System (MBS) phone.

The wireless/wireline communication network 120 connects the user terminal 110, web server 130, division search server 140, and index server 150 to one another in wireless or wireline manner to repeat data transmitted and received therebetween.

The web server 130 is a typical network server including a plurality of computer systems or computer software, which provides various information in web pages. The network server implies a computer system and computer software (network server program) that is connected to a sub-unit communicating with another network server over a computer network such as a private intranet or the Internet, receives an operation request, and provides operation results. However, in addition to the network server program, the network server should be construed to include application programs executed on the network server, and various databases stored therein. The network server may be embodied using network server programs offered according to an operating system, such as DOS, Windows, Linux, UNIX or MacOS.

The index server 150 executes a data collection program, which is typically referred to as a web robot, to collect data from the web servers 130 connected to the wireless/ wireline communication network 120. The index server 150 periodically updates the collected data, and the index DB 151 uses an inverted file or the like to store the collected data.

The division search server 140 communicates with the index server 150 and the index DB 151 to read web data and analyzes position information of the web data to create a plurality of position information patterns. The position information implies information including Internet paths of the collected web data. It preferably includes Uniform Resource Locators (URIs) of the web data. It extracts an HTML, template from a web page collected using the URL pattern, and uses the HTML template to divide the web page into a plurality of information blocks. In addition, a predefined template pattern may be used to improve a processing speed. The information blocks are divided in the web page according to its type or attribute, and consist of basic information, such as title, writer, number of references, or text, concerning the web page, and the content of text.

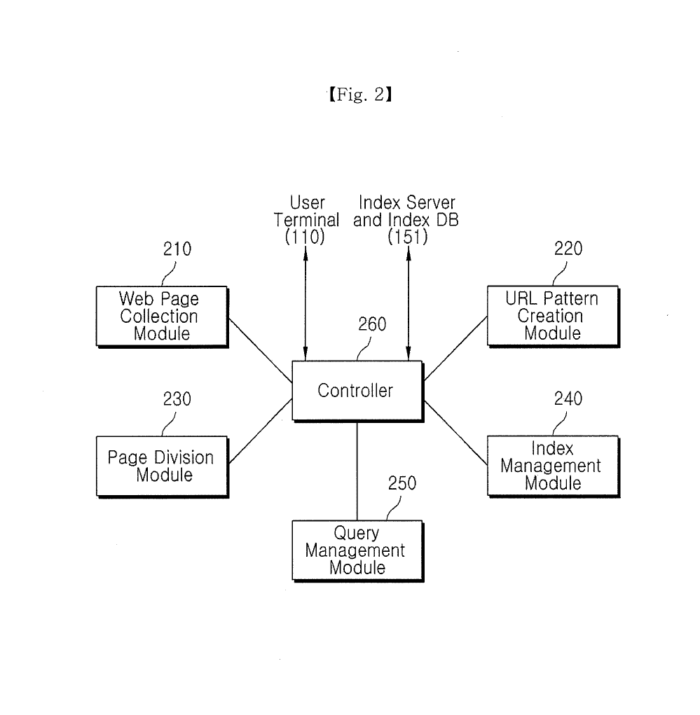

The division search server 140 divides a web page into a plurality of information blocks, makes an index of the web page in information block units, creates index information concerning each of the information blocks and URI, information concerning a reference web page referenced by the index, stores the index information and URL information in the division search DB 141, compares the query and the index to create a division search result upon receiving the query and search request signal from the user terminal 110, and transmits the division search result to the user terminal 110. The created division search result, together with other search results related to the query, may be transmitted to the user terminal 110. The division search server 140 will be described in detail with reference to FIG. 2.

The division search server 140 may search for the division search DB 141 and output a division search result related to a keyword without receiving the query and search request signal from the user. For example, the division search result may be recommended information concerning a title extracted in a predetermined method from web documents viewed by the user.

The division search DB 141 stores index information and position information (including URL information) of the reference web page, which are received from the division search server 140. The division search DB 141 stores the index information in information block units, and stores the URL information of the reference web page in the division search DB 141. The division search DB 141 and the index DB 151 may be separated from each other, or be integrated.

The DB implies a data structure configured in a storage area of a computer system through a Database Management System (DBMS) program, in which data is retrieved, deleted, edited, and added. The DB may be adapted to the present invention using a Relational Database Management System (RDBMS), such as Oracle, Informix, Sybase, Microsoft Structured Query Language (MS SQL), or DB2. The DB includes fields or elements required in storing, retrieving, deleting, editing, and adding data.

FIG. 2 is a block diagram of a division search server 140 according to an embodiment of the present invention.

The division search server 140 is a network server including a web page collection module 210, a URL pattern creation module 220, a page-dividing module 230, an index management module 240, a query management module 250, and a controller 260.

The web page collection module 210 accesses the web servers 130 over the wireless/wireline communication network 120 to collect data. The web page collection module 210 may be selectively included in the division search server 140 to reflect a change in data referenced by position information that is collected by the index server 150 and stored in the index DB 151.

The URL pattern creation module 220 analyzes URLs of web pages acquired by the controller 260 or web page collection module 210 to create URL patterns. In the present invention, the URI, pattern implies a predetermined pattern for generalizing web pages having similar patterns, i.e., web pages having the same basic structure. After web pages sharing a HTML template are divided into a plurality of information blocks in HTMI, template units, an information search is made in information block units. At this time, the URL pattern is used as a criterion required in selecting web pages sharing the HTML template.

That is, web pages sharing an equal HTML template tend to be created by the same operator and to include similar content. In addition, the web pages created by the same operator may be included in a plurality of pages that is managed by a web server offering board service, blog service, mini homepage service, and the like.

The HTML template implies a frequently used basic structure so that web pages can be easily written. For instance, it is written in tag form, such as <Table . . . ><TD>[text number]</TD><TD>[title]</TD>. . . </TABLE>, that is frequently used upon writing web pages. An HTML document written as a web page is typically a combination of an HTML tag and a text, which are written in compliance with HTML syntax. The HTML document consists of a plurality of function blocks, such as a menu block, a link block for connection with other portal sites, and a message block for containing texts. The function blocks are frequently used in web pages and are therefore written in templates for convenience of users.

Since the web server 130 offering the board service, blog service, and mini homepage service uses the HTML template to write most web pages managed by the web server 130, web pages managed by the same web server 130 share the same HTML template. Accordingly, the HTML template may be extracted from the web pages having the same URL pattern, and may be used to divide the web pages into a plurality of information blocks.

The page-dividing module 230 uses the URL, pattern created by the URL, pattern creation module 220 to extract an HTML template from a web page, and uses the HTML template to divide the web page into a plurality of information blocks.

The index management module 240 extracts indexes in information block units from the web page divided into the information blocks by the page-dividing module 230, and stores URL information referenced by the indexes in the division search DB 141. That is, the index management module 240 extracts the indexes from the web page in information block units, stores the indexes in the index DB 151 to correspond to the individual information blocks, and stores URL information of a reference web page referenced by each of the indexes in the division search DB 141.

Upon receiving a query or keyword from the user terminal 110, the query management module 250 receives from the division search DB 141 URL information of a reference web page referenced by an index that is equal or related to the query, and creates and transmits a division search result to the user terminal 110.

The query management module 250 searches for indexes indexed in information block units to create an information block based division search result and an entire division search result.

In the present invention, the information block based division search result is provided in information block units, and includes in each of the information blocks an index, which is equal or related to a query, and URL of a reference web page referenced by the index. For instance, when individual information blocks of title, writer, and text are indexed by the index management module 240 and individual indexes are stored in information block units in the index DB 151, the query management module 250 creates an information block based division search result that contains URL information of reference web pages referenced by an index equal or related to a query. Accordingly, the information block based division search result has URL information of reference pages with respect to the individual information blocks of title, writer, and text.

When a connection between the query and index is determined, the query and index are not necessary to be physically equal to each other. The query and index are rega rded to be related to each other even though both are partly equal to each other through morpheme analysis or n-gram. The search result may further include a case in which both belong to the same category or have similar meaning in a classified term dictionary.

Meanwhile, the entire division search result includes an index equal or related to a query and URL information of a reference web page referenced by the query, in which the URL information of the reference web page has a priority order determined according to an evaluation value calculated based on different weights put on individual information blocks by the query management module 250. That is, as described above, when individual information blocks of title, writer, and text are indexed by the index management module 240 and individual indexes are stored in information block units in the index DB 151, the query management module 250 searches for an index equal or related to the query in information block units in the index DB 151. When the index equal or related to the query is detected in the index DB 151, an evaluation value is calculated from different weights put on the individual information blocks. The priority order of URL information of a reference web page referenced by the index is determined based on the evaluation value, and the URL information of the reference web page is sorted according to the priority order, such that the entire division search result is created.

The controller 260 controls the web page collection module 210, URL pattern creation module 220, page-dividing module 230, index management module 240, and query management module 250 so that the division search server 140 can use a divided page to make a search. In addition, the controller 260 controls so that the division search server 140 can communicate with the wireless/wireline communication network 120, division search DB 141, index server 150, and index DB 151.

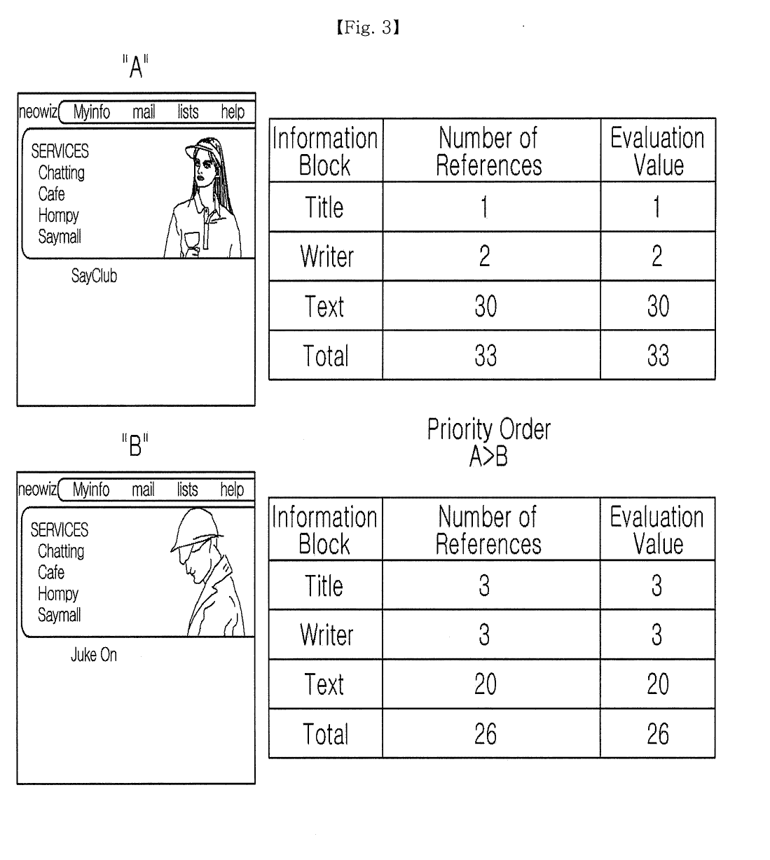

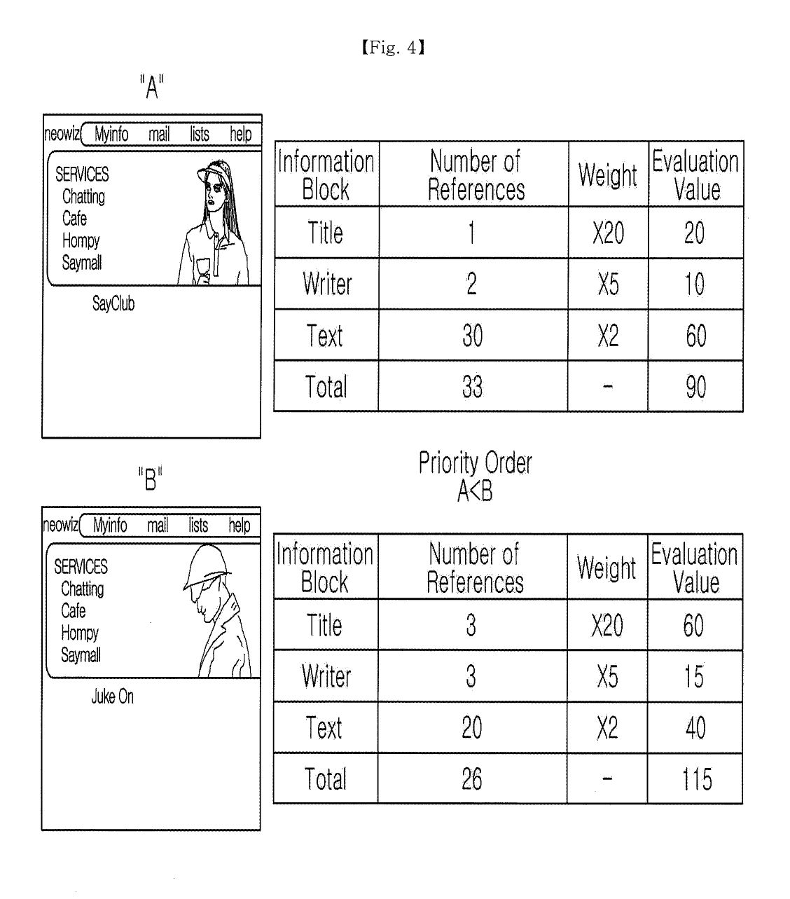

FIGS. 3 and 4 are views for explaining a method of determining a priority order according to an embodiment of the present invention.

FIG. 3 is a view for explaining a conventional method of determining a priority order. It is assumed that there are two web pages, “A” and “B” containing a query inputted by a user. When a priority order is determined between the two web pages in a conventional search method, the frequency of the query is simply counted to calculate an evaluation value. That is, in the conventional search method, each of the web pages is not divided into individual information blocks of ‘title’, ‘writer’ and ‘text’ and weights are not put on the individual information blocks. Thus, an evaluation value for determining a priority order of the web page “A” is (1×1=1)+(2×1=2)+(30×1=30)=33, and an evaluation value for the web page “B” is (3×1=3)+(3×1=3)+(20×1=20)=26. Accordingly, since the frequency of the query in the web page “A” is more than the frequency of the query in the web page “B”, the web page “A” is higher in priority than the web page “B”.

FIG. 4 is a view for explaining a method of determining a priority order according to an embodiment of the present invention. A web page is divided into information blocks, such as ‘title’, ‘writer’ and ‘text’. An evaluation value is calculated from weights (including ‘0’) put on the individual information blocks based on user's preference or service policy, and the priority order of the web page is determined based on the evaluation value. As shown in FIG. 4, when weights of ‘×20’,‘×5’, and ‘×2’ are put on the information blocks ‘title’, ‘writer’ and ‘text’, respectively, an evaluation value for determining the priority order of the web page “A” is (1×20=20)+(2×5=10)+(30×2=60)=90, and an evaluation value for the web page “B” is (3×20=60)+(3×5=15)+(20×2=40)=115. Thus, since the web page “A” is higher in frequency of query than the web page “B” but the web page “A” is lower in evaluation value than the web page “B”, the web page “B” is higher in priority than the web page “A”.

Accordingly, when a user intends to search for a ‘title’ of a web page, the user can obtain a more reliable search result by using the search method according to the present invention.

When the priority order of URL information of a reference web page is determined, an unindexed information block, together with an indexed information block, is a significant criterion for determining the priority order. For example, when a web page includes an information block for indicating the number of references, and the information block about the number of references is not indexed, the priority order of the URL information of the reference web page may be changed by determining the priority order of the URL information of the reference web page and referring to the number of references.

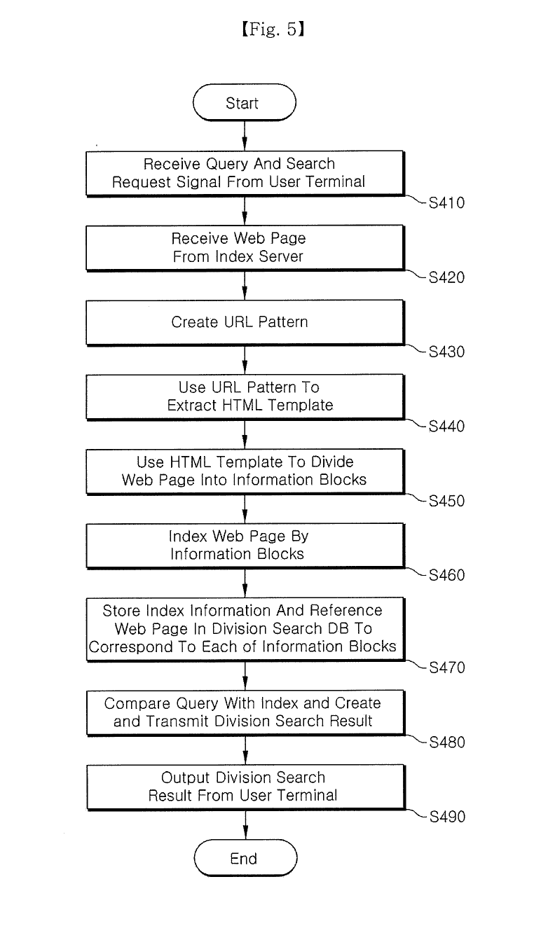

FIG. 5 is a flow chart of a method of providing an information search service using a web page divided into a plurality of information blocks according to an embodiment of the present invention.

An Internet user uses the user terminal 110 to input a query, and transmits the query and a search request signal to the division search server 140 over the wireless/wireline communication network 120 (operation S410). The operation S410 may be omitted. That is, a division search service may be performed by analyzing stored data without inputting the query or query request signal from the user.

After receiving the query and search request signal from the user terminal 110, the division search server 140 executes a web robot program to receive web pages from the web server 130 accessed to the wireless/wireline communication network 120 (operation S420). The division search server 140 may execute the web robot program according to a predetermined method without receiving the query or search request signal from the user to receive web pages and store data.

After receiving the web pages from the web server 130, the division search server 140 analyzes the web pages to create URL patterns (S430).

After creating the URL patterns, the division search server 140 uses the URL pattern to extract a HTMI, template from the web page (operation S440), and uses the HTML template to divide the web page into a plurality of information blocks (operation S450).

After dividing the web page, the division search server 140 extracts an index from information contained in each of the information blocks to create index information, and creates URL information of a reference web page referenced by the index (operation S460).

After creating the index information and the URL information of the reference web page, the division search server 140 stores the indexes in the index DB 151 to correspond to the individual information blocks, and stores the URL information of the reference web page referenced by the index of each of the information blocks in the division search DB 141 (operation S470).

After indexing, the division search server 140 searches for the query received from the user terminal 110 in the index DB 151, and creates and transmits a division search result to the user terminal 110 (operation S480). That is, the division search server 140 compares the query with the index stored in the index DB 151 to create and transmit an information block based division search result to the user terminal 110. Alternatively, the division search server 140 searches for an entire index among index information stored in the index DB 151 to create and transmit an entire division search result to the user terminal 110.

After receiving the division search result from the division search server 140, the user terminal 110 outputs the search result to a display unit (operation S490). The division search service according to the present invention may be provided even though the query is not input from the user.

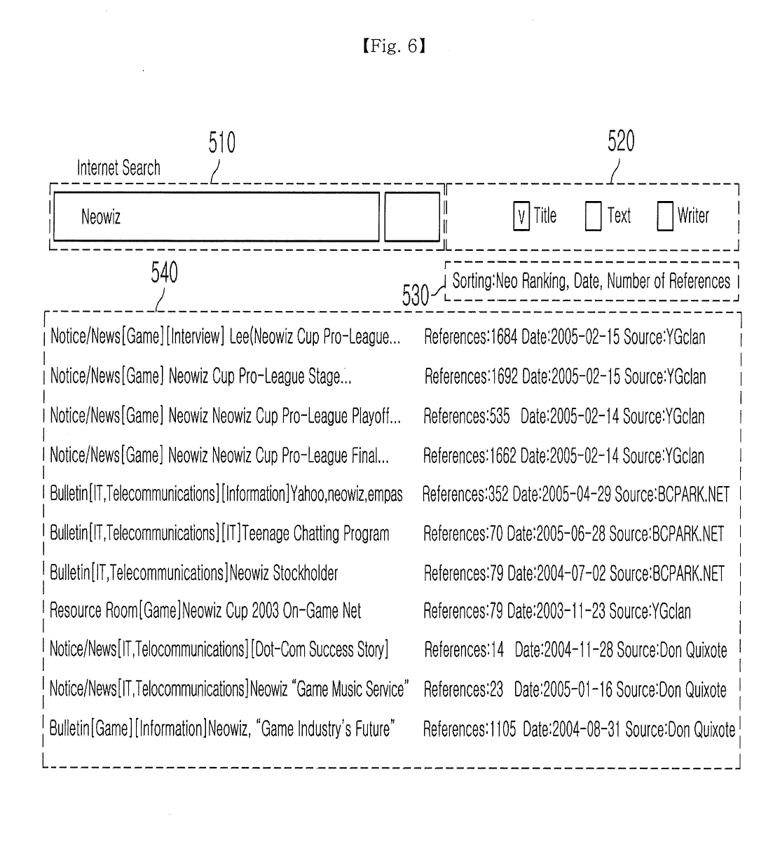

FIG. 6 is a view for explaining a division search result according to an embodiment of the present invention.

A division search service may be used to search for content contained in web pages on the Internet. A user inputs a query “Neowiz” in an input window 510 in a web page providing a division search service and selects a ‘search’ item. The user may select one of items, ‘title’, ‘text’ and ‘writer’ in a search setup window 520 according to the type or attribute of information and put weight on the selected item. In FIG. 6, since the item ‘title’ is selected, web pages containing the query in the title are output in the first place.

When the query is input in the input window 510 and the search item is selected in the search setup window 520, a division search result 540 is output as shown in FIG. 6. The division search result 540 is sorted in a ‘Neo ranking order’ in a sorting menu 530. The user may change a sorting order in the division search result 540 by selecting ‘date’ or ‘number of references’ in the sorting menu 530.

While the present invention has been described with reference to exemplary embodiments thereof, it will be understood by those skilled in the art that various changes in form and details may be made therein without departing from the scope of the present invention as defined by the following claims.

### INDUSTRIAL APPLICABILITY

The present invention can be efficiently adapted to a method, system, and server for providing an information search service using a web page divided into a plurality of information blocks.

1. A method of providing a division search service, comprising:
(a) analyzing collected data to divide each of the data into a plurality of information blocks;
(b) creating an index of each of the information blocks; and
(c) comparing the index with a keyword, creating a division search result of the keyword based on a relevance between the index and the keyword, and providing the division search result.

2. The method of claim 1, wherein position information of the data includes Uniform Resource Locator (hereinafter referred to as URL) information of the collected data, and a pattern of the position information is a predetermined pattern for generalizing web pages having the same basic structure and serves as a criterion for selecting web pages sharing a markup language template.

3. The method of claim 1 or 2, wherein the operation (a) comprises:
(a1) analyzing the collected data to create a position information pattern of the data;
(a2) analyzing a set of data determined to have a relevance therebetween based on the position information pattern; and
(a3) using the template to divide the data into a plurality of information blocks.

4. The method of claim 3, wherein the information block in the operation (a3) includes a type or attribute of information contained in the data, and is written with the markup language template.

5. The method of claim 1 or 4, wherein the division search result in the operation (c) is sorted according to an evaluation value calculated by a predetermined method.

6. The method of claim 1, further including collecting and indexing data on the Internet prior to the operation (a).

7. A method of providing a division search service in a system including a user terminal transmitting a query and outputting a search result, a web server providing a plurality of web pages, and a division search server receiving the query from the user terminal and creating and transmitting the search result to the user terminal, the method comprising:
(a) receiving the query and a division search request signal from the user terminal;
(b) receiving a web page from the web server;
(c) dividing the web page into a plurality of information blocks;
(d) extracting an index corresponding to each of the information blocks from the divided web page and creating index information and URL information of a reference web page referenced by the index; and
(e) searching an index that is equal or related to the query to create a division search result, and transmitting the division search result to the user terminal.

8. The method of claim 7, wherein the operation (c) comprises:
(c1) analyzing the web page to create an URI, pattern;
(c2) converting URL of the web page to the URL pattern;
(c3) using the URL pattern to extract a HyperText Markup Language (hereinafter referred to as HTML) template from the web page; and
(c4) using the HTML, template to divide the web page into a plurality of information blocks.

9. The method of claim 8, wherein the URL pattern is a predetermined pattern for generalizing web pages having the same basic structure as the web page, and serves as a criterion for selecting web pages sharing the HTML template.

10. The method of claim 8, wherein the information block in the operation (c4) includes a type or attribute of information contained in the web page, and is written with the HTML template.

11. The method of claim 7, wherein the operation (d) comprises:
(d1) extracting the index corresponding to each of the information blocks from the divided web page to create index information and storing the index information in a division search database (hereinafter referred to as DB); and
(d2) creating URL information of the reference web page referenced by the index and storing the URL information in the division search DB.

12. The method of claim 7, wherein the operation (e) comprises:
(e1) searching for the index equal or related to the query from each of the information blocks;
(e2) searching for URL information of the reference web page referenced by the index searched from each of the information blocks in the operation (e1); and
(e3) creating as the division search result the URL information of the reference web page searched from each of the information blocks in the operation (e2) and transmitting the division search result to the user terminal.

13. The method of claim 12,
wherein the operation (e3) creates the division search result including an entire division search result or information block based division search result,
the entire division search result being created by determining a priority order based on a ranking system by putting different weights on the individual information blocks to calculate an evaluation value, and sorting the URL information of the reference web page according to the priority order, and the information block based division search result including the index equal or related to the query in each of the information blocks, and the URL information of the reference web page.

14. The method of claim 13, wherein the operation (e3) uses both indexed information blocks and unindexed information blocks to determine the priority order when the entire division search result is created.

15. A system for providing a division search service from information in a plurality of web pages on a wireless/wireline communication network, comprising:
a user terminal performing web surfing over the wireless/wireline commmunication network, transmitting a query and a search request signal, receiving and outputting a division search result to a display unit;
a web server creating the information as a plurality of web pages; and
a division search server dividing the web page into a plurality of information blocks, using the divided web page to search for the information, creating and transmitting the division search result to the user terminal.

16. The system of claim 15, wherein the division search server comprises:
a web page collection module executing a web page collection program to receive the web pages from the web server accessing the wireless/wireline communication network and store the web pages;
a URL pattern creation module analyzing the web pages to create the URL pattern;
a page-dividing module using the URL pattern to extract a HTML template from the web page, and using the HTML, template to divide the web page into a plurality of information blocks;
an index management module extracting an index corresponding to each of the information blocks in the divided web page to create and store index information and URL information of a reference web page referenced by the index;
a query management module receiving the query and the information search request signal from the user terminal, searching for an index equal or related to the query, creating and transmitting a division search result to the user terminal; and
a controller controlling the web page collection module, the URL, pattern creation module, the page-dividing module, the index management module, and the query management module so that the division search server can use the divided web page to make a search, and controlling so that the division search server can communicate with the user terminal and the web server over the wireless/wireline communication network.

17. The system of claim 16, wherein the URL pattern creation module is a predetermined pattern for generalizing web pages having the same basic structure as the web page to create the URL pattern, the URL pattern serving as a criterion for selecting web pages sharing the HTML template.

18. The system of claim 16, wherein the information block includes a type or attribute of information contained in the web page, and is written with the HTML template.

19. The system of claim 16, wherein the query management module searches for the index equal or related to the query from each of the information blocks, searches for the URL information of the reference web page referenced by the index searched from each of the information blocks, creates as the division search result the URL information of the reference web page searched from each of the information blocks, and transmits the division search result to the user terminal.

20. The system of claim 16,
wherein the query management module creates the division search result including an entire division search result or information block based division search result,
the entire division search result being created by determining a priority order based on a ranking system by putting different weights on the individual information blocks to calculate an evaluation value, and sorting the URI, information of the reference web page according to the priority order, and the information block based division search result including the index equal or related to the query in each of the information blocks, and the URL information of the reference web page.

21. The system of claim 20, wherein the query management module uses both indexed information blocks and unindexed information blocks to determine the priority order when the entire division search result is created.

22. The system of claim 15, further including a division search DB having an index DB storing the index information received from the division search server, and a URL DB storing the URL information of the reference web page.

23. A server for providing a division search service, comprising:
a page-dividing module analyzing collected data to divide each of data into a plurality of information blocks;
an index management module creating an index of each of the information blocks; and
a controller comparing the index with a keyword, creating a division search result of the keyword based on a relevance between the index and the keyword, and providing the division search result.

24. The server of claim 23, wherein the page-dividing module analyzes the collected data to create a position information pattern of the data, uses the position information pattern to extract a markup language template, and uses the template to divide the data into a plurality of information blocks.

25. The server of claim 23 or 24, wherein the position information includes URL of a web page at which the collected data is positioned.

26. The server of claim 23, further including a web page collection module collecting data from web pages on the Internet beforehand.

27. A server for providing a division search service by receiving a query and a search request signal from a user terminal performing web surfing over a wireless/wireline communication network, searching for information on a web page provided by a web server, and transmitting a search result to the user terminal, the server comprising:
a web page collection module executing a web page collection program to receive the web pages from the web server accessing the wireless/wireline communication network and store the web pages;
a URL pattern creation module analyzing the web pages to create the URL pattern;
a page-dividing module using the URL pattern to extract a HTML template from the web page, and using the HTML template to divide the web page into a plurality of information blocks;
an index management module extracting an index corresponding to each of the information blocks in the divided web page to create and store index information and URI, information of a reference web page referenced by the index;
a query management module receiving the query and the information search request signal from the user terminal, searching for an index equal or related to the query, creating and transmitting a division search result to the user terminal; and
a controller controlling the web page collection module, the URL pattern creation module, the page-dividing module, the index management module, and the query management module so that the division search server can use the divided web page to make a search, and controlling so that the division search server can communicate with the user terminal and the web server over the wireless/wireline communication network.

28. The server of claim 27, further including a division search DB having an index DB storing the index information, and a URL DB storing the URL information of the reference web page.
